(19) United States
(12) Patent Application Publication
(10) Pub. No.: US 2016/0325185 A1
(43) Pub. Date: Nov. 10, 2016

(54) ROLE PLAYING GAME NOTEBOOK APPLICATION

(71) Applicant: ERIN ASHLEY OSBORNE, HARVEST, AL (US)

(72) Inventor: ERIN ASHLEY OSBORNE, HARVEST, AL (US)

(21) Appl. No.: 14/705,560

(22) Filed: May 6, 2015

(51) Int. Cl. A63F 13/79; A63F 13/822

(52) U.S. Cl. CPC A63F 13/79; A63F 13/822

(57) ABSTRACT

A method and system of collecting and storing information relating to a players participation in a Role Playing Game wherein a server is used to transform the information into an electronic notebook. The method and system includes a game client configured as an application on an electronic device of a player. The electronic notebook comprises a plurality of Web pages that can be edited, searched, and sorted. The notebook includes social tools, such as the ability to invite other players to join a players game and to join the role playing game of another, and the ability to transfer a player's notebook to the notebook of another player. Web pages of the notebook will be generated relating to quests and campaigns the player participates in, non-player characters utilized in the game, places and items utilized in the game, and notes relating to the game.

### CROSS-REFERENCE TO RELATED APPLICATIONS

Not applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR JOINT INVENTOR

The inventor did not disclosed the invention herein prior to the 12 month period preceding the filing of this nonprovisional application.

### BACKGROUND OF THE INVENTION

(1) Field of the Invention

A method and system for collecting information relating to role playing games and storing the information as a personal electronic notebook. The present invention generally relates to a computer application for automatic creation of a personal campaign notebook for both online and offline game players comprised of screens that store personal data and game content relating to the users' participation in role playing games. The player sends both personal data and game content over an electronic network to a game server, such that a personal electronic notebook comprising the personal data and game content of a game currently being played or previously played is generated online and is accessible to authorized players via their personal computer, laptop computer, the Internet, notebook device, mobile phone, or other electronic device.

(2) Description of Related Art

Many games incorporate role playing. The following list includes just a few of the numerous role playing games currently played: Dungeons and Dragons®, Pathfinder®, Savage Worlds®, Gurps®, and Hackmaster®. These games can have complex story lines with a multitude of players and numerous locations of play. Typically, each player controls a single player character (hereinafter “PC”) that works in a group with other player characters. A game continues over a series of meetings to complete a single adventure or “Quest”, and longer into a series of related gaming adventures, called a “Campaign”. The PC encounter a number of other PCs and non-player characters (hereinafter “NPC”) during the Quests and Campaigns. These encounters often take the form of battles with monsters. Each PC maintains a handwritten log on paper to record what transpires during each Quest within a Campaign. These paper logs are easily misplaced and lost. Additionally, items regarding each Quest and Campaign may be omitted through inadvertence or recorded incorrectly by the player. The only way to share this information with other players is to show them the handwritten log. A method or system of storing this information on an electronic device wherein it can be easily and quickly retrieved, manipulated, and shared is needed.

Other devices have been disclosed to assist players of role playing games in event notification and the creation of web pages. Aguilar et al. (US 2008/0090679 A1 and U.S. Pat. No. 8,734,254 B2) disclose a mechanism for generating event notifications for offline characters from within a persistent world maintained by a game server. The persistent world is hosted by a server and the persistent world continues to change even when a player is not logged in. This device provides an electronic message to a player so that the player will receive a notification of certain game events that trigger an offline player rule even when the player is logged off. These devices do not allow for the creation of a notebook to record characters, quests, campaigns, etc.

Leifenberg et al. (US 2008/0227553 A1) discloses a system for the creation of a web page of an online game player and feed of personal data and game content to the pages for each of a plurality of game players. All game data is sent to the server and all players have the data available to them. Leader boards track statistics for all current players. Each player is able to add personal information such as their personal identity, avatar, character, team, assets data, digital assets, description, etc. This invention creates a personal notebook that publishes all data to a web page accessible to all players. In the invention herein, an electronic notebook is created for each user. The notebook is only accessible to other users designated by the player. Each player decides what content to add to the electronic notebook. The application herein does not track statistics for current players and create a leader board to rank players. The notebook herein is created to contain the data relevant to a particular quest, campaign, etc.

Brown et al. (U.S. Pat. No. 8,930,490 B2) discloses a method and system for collecting information, enriching the collected information and linking the enriched information electronically. Information collected by this invention includes information relating to every day aspects of a user's life including work, relationships, health, entertainment, news, etc. This device seeks to organize disorganized information floating around many user's lives and brains. Although this device discloses a method to organize information, this application is dissimilar to the invention disclosed herein. The Role Playing Game Notebook Application actually transforms the data it receives into a personal electronic notebook. The Role Playing Game Notebook Application records information relating to characters, quests, campaigns, and other game elements of a role playing game such as Dungeons and Dragons® in an electronic fashion so that the information is readily available to a player.

### BRIEF SUMMARY OF THE INVENTION

Many of the role playing games currently available to users require each player to maintain a handwritten log to record information regarding events that occur during the game. The Role Playing Game Notebook is an application that stores information relating to role playing games in a format that is easily accessible to a player so that the player no longer needs to maintain a handwritten log. The present invention utilizes a server to send data relating to campaigns, quests, non-player characters, player characters, items encounter during events, the place where events occur, and notes to be saved for recall. The data is saved in a notebook format and can be accessed by a user or authorized person. The material is accessible via personal computer, smart telephone, electronic notebook, or other electronic device. Because the application is so easy to use and readily accessible on one's personal electronic device, a player is more likely to accurate maintain events in a role playing game and is less likely to misplace or loose the notebook in an electronic format.

A system and method is disclosed for collection of information relating to a a player's participation in a role playing game, enriching the collected information and transforming it into an electronic notebook, and linking the electronic notebook is provided. The system includes an application server that is accessible by users via their computer device for performing a variety of functions encompassed in a role playing game. The electronic notebook is a plurality of Web pages to which a player feeds personal content and game content. The personal electronic notebook of a player may be accessed by other players as authorized. The system and method includes a game client configured as an application on an electronic device of the player and automatically generated plurality of personal Web pages for each game player, wherein the application sends the personal data and the game content over an electronic network to the game server, such that a plurality of personal Web pages comprising the personal data and the game content of a role playing game being player by each of the game players is generated online and is accessible to authorized game players.

The electronic notebook holds data from the role playing game and includes data and content relating to the players campaigns, quests, non-player characters, items, places, and notes. The system and method also generates role playing game related content, such as pictures and text and sends it to the electronic notebook to be published. The electronic notebook is either created as a part of an independent Web host or as a part of a central Web site, that also includes social tools, such as the ability to invite other players to join a players role playing game, to join the role playing game of another, and the ability to transfer a player's personal electronic notebook data and content to the electronic notebook of another player.

The user device operated by players to access the application server is a mobile device that communicates with the application server over a wireless network. The system and method is provided for collecting personal data and game content, transforming the data and game content into an electronic notebook comprising a plurality of Web pages, and linking the electronic notebook. The system and method includes an application server that is accessible by a plurality of users each with their own computer device for performing a variety fo functions encompassed in a role playing game. The goal of the electronic notebook is to provide the role playing game participant with: (a) better organization of his/her data, notes, thoughts and intentions, (b) a better search or filter tool to search for personal data, game content, notes, and/or (c) a better mechanism for social interaction with other players of the role playing game.

### BRIEF DESCRIPTION OF THE SEVERAL VIEWS OF THE DRAWINGS

FIG. 1 is a diagram illustrating the distributed data processing system of the Role Playing Game Notebook Application.

FIG. 2 is a flow chart illustrating an overview of the Role Playing Game Notebook Application.

FIG. 3 is a flow chart illustrating the log in procedure.

FIG. 4 is a flow chart illustrating the process to create a new user account.

FIG. 5. is a flow chart illustrating the process for a user that has forgotten his or her password.

FIG. 6. is a flow chart illustrating the process to exit the Role Playing Game Notebook application.

FIG. 7. is a flow chart illustrating the process to edit a story.

FIG. 8 is a flow chart illustrating the process to invite other players to join a story.

FIG. 9 is a flow chart illustrating the process for the user to join a story following an invitation from another user.

FIG. 10 is a flow chart illustrating the process to retrieve or create a story.

FIG. 11 is a flow chart illustrating the process of selecting a “Navigation Menu” option.

FIG. 12 is a flow chart illustrating the process of selecting “Story Sub Menu” options.

FIG. 13 is a flow chart illustrating the process to sort what will be displayed.

FIG. 14 is a flow chart illustrating the process of editing notebook content.

FIG. 15 is a flow chart illustrating the process of retrieving and creating a “Campaign Log” notebook page.

FIG. 16 is a flow chart illustrating the process of retrieving and creating a “Quest” notebook page.

FIG. 17 is a flow chart illustrating the process of retrieving and creating a “Non-Player Character” notebook page.

FIG. 18 is a flow chart illustrating the process of retrieving and creating a “Item” notebook page.

FIG. 19 is a flow chart illustrating the process of retrieving and creating a “Place” notebook page.

FIG. 20 is a flow chart illustrating the process of retrieving and creating a “Note” notebook page.

FIG. 21 is a flow chart illustrating the process of selecting “User Account Menu” options.

FIG. 22 is a flow chart illustrating the process to change a user's password.

FIG. 23 is a flow chart illustrating the process to delete a user account.

FIG. 24 is a flow chart illustrating the process to transfer information relating to one or more stories to another user.

FIG. 25 is a continuation of the flow chart of FIG. 23.

FIG. 26 is a flow chart illustrating the process for leaving a story.

FIG. 27 is a flow chart illustrating the process for deleting a story from the electronic notebook.

FIG. 28 is a flow chart illustrating the “Back Function” to go back to a previous screen.

### DETAILED DESCRIPTION OF THE INVENTION

The invention is described in detail in the following paragraphs with reference to the attached drawings. Throughout this detailed description of the invention, the disclosed embodiments and features are to be considered as examples, rather than being limitations to the invention. Modifications to particular examples within the spirit and scope of the present invention, set forth in the appended claims, will be readily apparent to one of ordinary skill in the art. Further, reference to various embodiments of the disclosed invention does not mean that all claimed embodiments or methods must include every described feature. The various disclosed embodiments and features of the invention may be used separately or together, and in any combination. Terminology used herein is given its ordinary meaning consistent with the exemplary definitions set forth below.

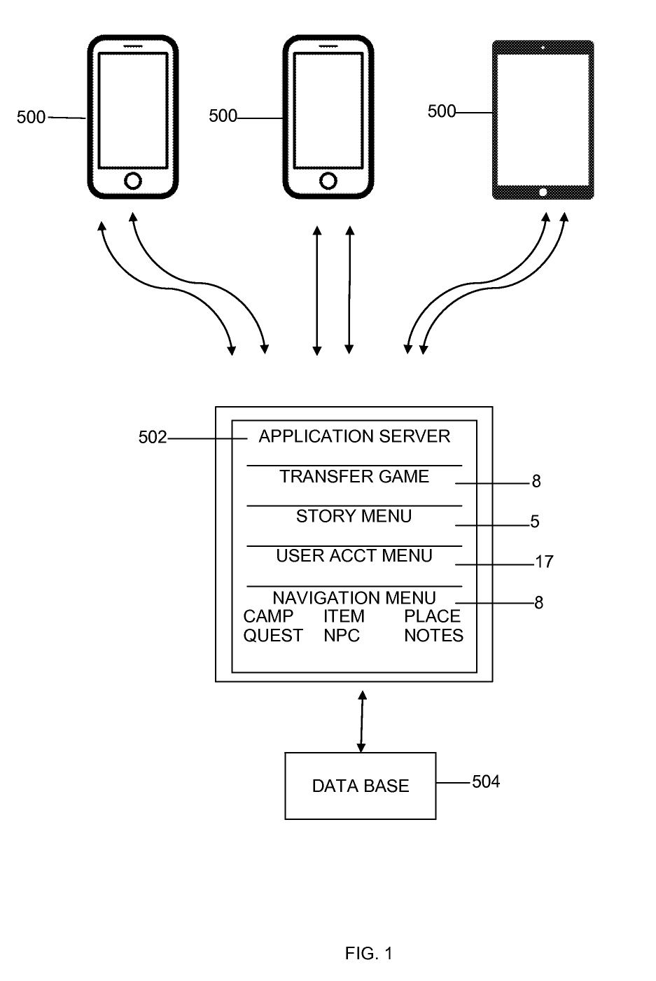

With reference to the figures, FIG. 1 depicts a pictorial representation of an exemplary distributed data processing system in which aspects of the illustrative embodiments may be implemented. The distributed data processing system may include a network of computers in which embodiments of the illustrative embodiments may be implemented. The distributed data processing system contains at least one network 500, which is the medium used to provide communication links between various devices and computers connected together within the distributed data processing system. The network 500 may include connections, such as wire, wireless, communication links, or fiber optic cables.

In distributed data processing system of FIG. 1, server 502 is connected to a network along with data base 504, which is utilized for storage. Players are connect to the network 50 through their electronic device 500. Electronic devices 500 may include a personal computer, a mobile phone or smart phone, a laptop computer, the Internet, or a proprietary website. In the depicted example, server 502 may provide data, such as boot files, operating system images, and applications to the electronic device 500. In this instance, electronic devices 500 are clients to server 502 in the depicted example. The distributed data processing system may include additional servers, game clients, and other devices not shown.

More particularly, the server 502 may provide a server for maintaining the electronic notebooks of players. The server 502 allows the player to transfer between games 8, access the “Story” menu 5, access the “User Account” menu 5, and access the “Navigation” menu 8. The “Navigation” menu 8 allows the player to enter personal content and game data relating to: campaigns, quests, non-player characters, items, places, and miscellaneous notes. The server 502 may run role playing game notebook application software and maintain a database 504 for storage of personal data, game content, and electronic notebook Web pages for all players.

Electronic devices 500 may run role playing game notebook software that a player uses to interact with the electronic notebook. The player is considered online when the player is logged into the game server 502 through an electronic device 500. While online, players may: (a) enter personal data and game content, (b) view their electronic notebook(s), (c) edit and delete their electronic notebooks, (d) filter and search their electronic notebook(s), (e) sort their electronic notebook(s), (f) invite other players to join their electronic notebook(s), (g) join the electronic notebook(s) of other players, and (h) transfer data and content from their electronic notebook(s) to the electronic notebook(s) of another player. Whenever a player enters personal data or game content while using the Role Playing Game Notebook, the application automatically transforms the data into a Web page(s) and updates their Web page(s).

In one embodiment, the server 502 may run a Web server application, which provides Web-based user interfaces for reading or composing player invitations and transferring player data and game content. Thus, the player may configure an electronic notebook through a Web interface without the need for a graphics-intensive game client.

The example depicted in FIG. 1, the distributed data processing system is the Internet with an electronic network representing a worldwide collection of networks and gateways that use the Transmission Control Protocol (TCP/IP) suite of protocols to communicate with one another. The distributed data processing system may be implemented to include a number of different networks, such as an intranet, a local area network (LAN), a wide area network (WAN), or the like.

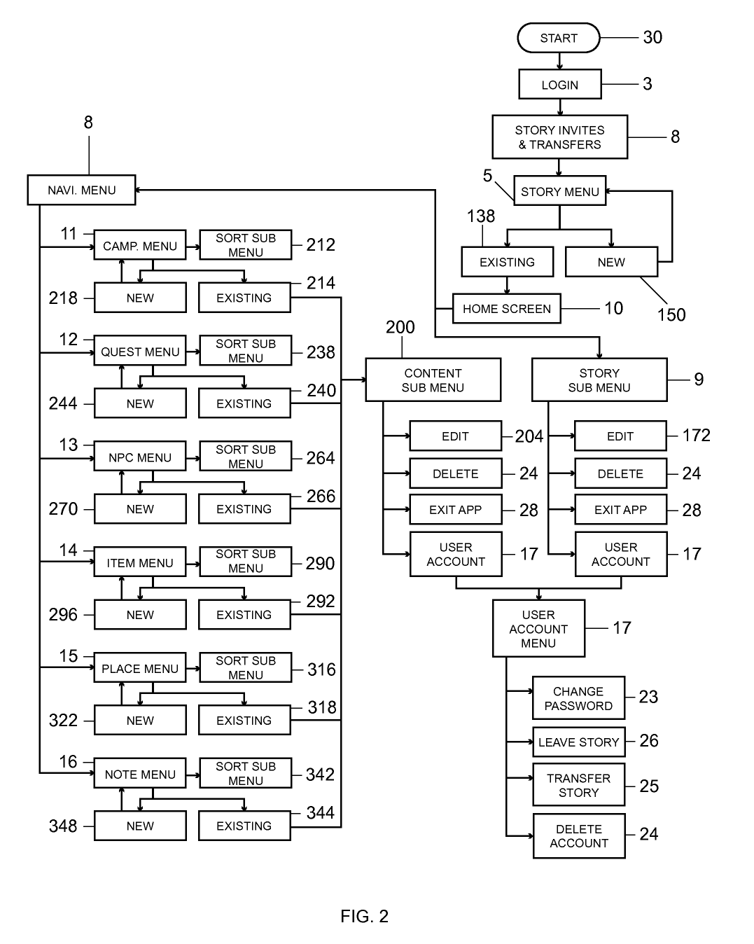

FIG. 2 is a flow chart illustrating an over view of the Role Playing Game Notebook Application. The player starts at Box 30 and logs into the application at Box 3. The player is then informed of any invitations to join an ongoing story and also made award of any story transfers, Box 8. The user proceeds to the “Story Menu” at Box 5. Upon selecting an “Existing Story” at Box 138, the player is forwarded to the “Home Screen” at Box 10. Next, the player chooses to either enter the “Story Sub Menu” at Box 9 or to go to the “Navigation Menu” at Box 8. The “Story Sub Menu” at Box 9 allows the player to edit and delete the story, exit the application, leave or transfer the story, change passwords, and delete the account. The “Navigation Menu” at Box 8 allows the player to create and modify the following menus: campaign, quest, non-player characters, items, places, notes, and content.

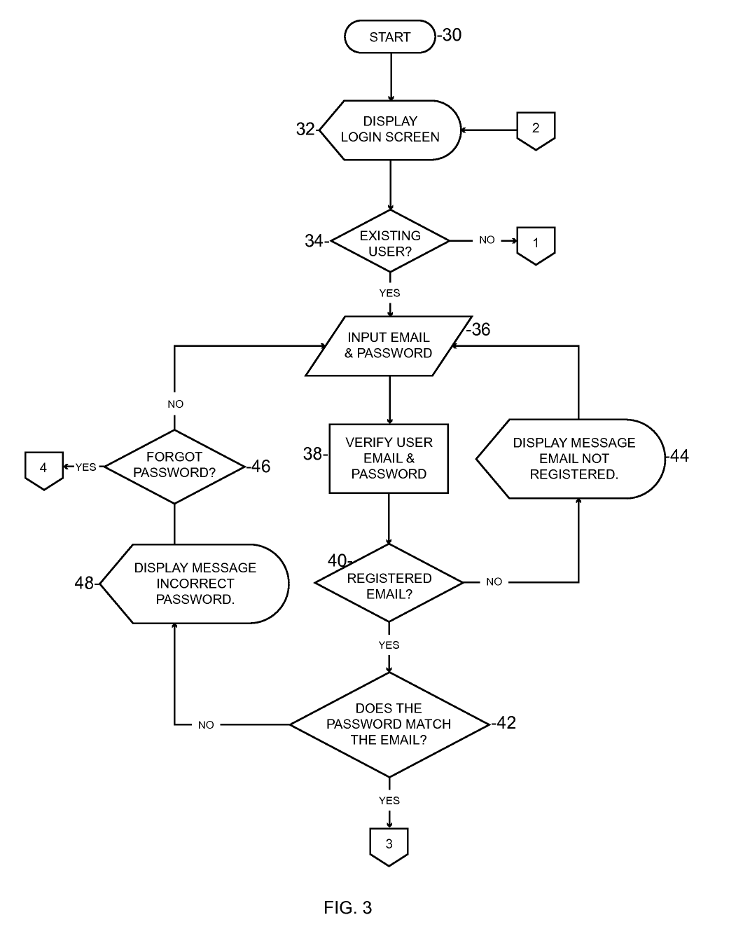

The log in process is depicted in FIG. 3. When the user starts the application at Box 30, the log in screen will be displayed, Box 32, on the screen of the electronic device. Upon confirmation that an existing user is attempting to log on at Box 34, the user will input their email and password information at Box 36. If a new user attempts to log on at Box 34, then the application will initiate the process of creating new user information, Box 1. Once the email and password information have been verified by the user at Box 36, the application will inquire whether the email address is a registered email at Box 40. If the email is verified at Box 40, then the application will confirm that the password provided by the user matches the stored password at Box 42. If the password entered by the user matches the stored password, the application will proceed to Box 3 to the “Story Sub Menu”. If the registered email address can not be verified at Box 40, then the application will display on the screen of the electronic device that the email is not registered, Box 44. If the password can not be verified at Box 42, then the application will display a message to inform the user that an incorrect password has been entered, Box 48. The application will then prompt the user to confirm whether the password has been forgotten at Box 46. If the password has been forgotten by the user, the application will send the password to the email account of the user at Box 4.

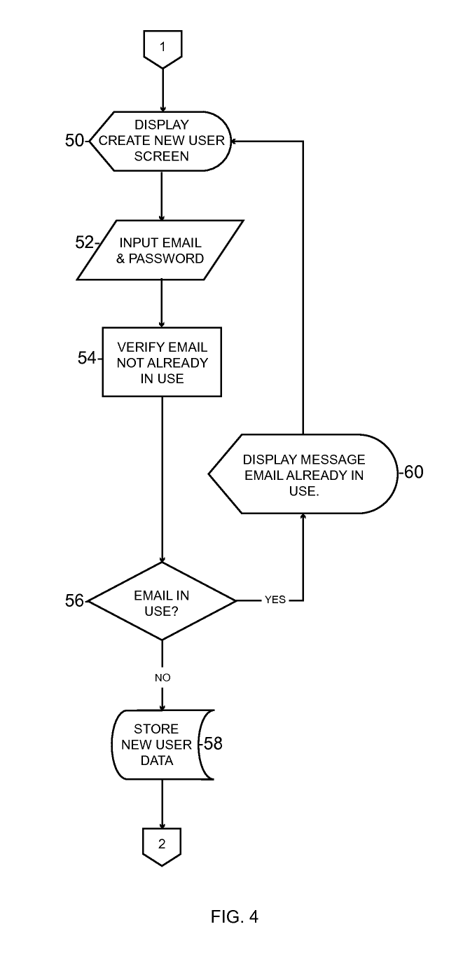

FIG. 4 is a flow chart depicting the process that the application utilizes to create a new user account beginning at Box 1. The application displays a message to the user to create a new user account at Box 50. The user then inputs their email and password information at Box 52, and the application verifies that the email entered is not currently in use by another at Box 54. If the email is not in use at Box 56, the application will store the new user data at Box 58 and proceed to Box 2 and display the “Log In” screen, Box 32. If the email is currently in use at Box 56, the application will display a message on the electronic device to indicate that the email is already in use at Box 60, and the application will proceed to display a message to create a new screen user account, Box 50.

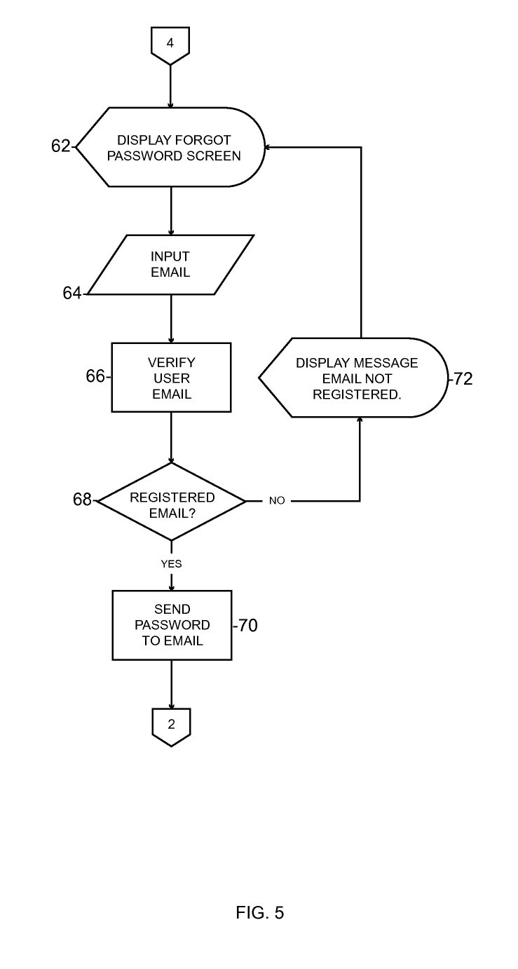

The process the application utilizes to send a forgotten password to the user is depicted in FIG. 5. If the user has forgotten their password at Box 4, then the application will display a message indicating that the password has been forgotten at Box 62. Next, the user is prompted to enter their email address at Box 64 so that the application can verify the email, Box 66. If the email is registered with the application at Box 68, the password will be sent to the email account listed for the user, Box 70, and the application will proceed from Box 2 to display the Log In” screen at Box 32. If the email is not registered with the application, then a message to indicate that the email is not registered will be displayed, Box 72, and the application will display a message prompting the user that he or she has forgotten their password at Box 62.

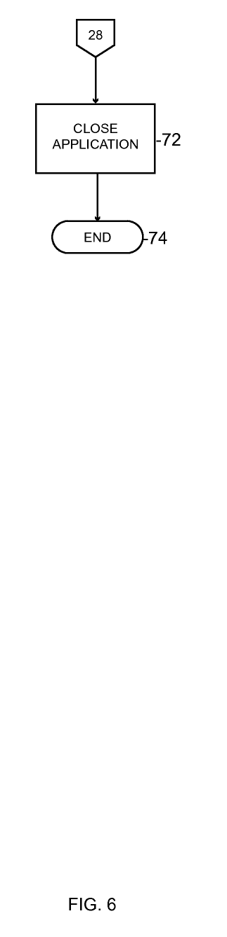

FIG. 6 is a flow chart depicting the process of closing the Role Playing Game Notebook Application. When the user decides to close the application, Box 28, the application proceeds through the close application process at Box 72, and shuts down the application while saving all changes made, Box 74. The application can be closed at multiple points during the application.

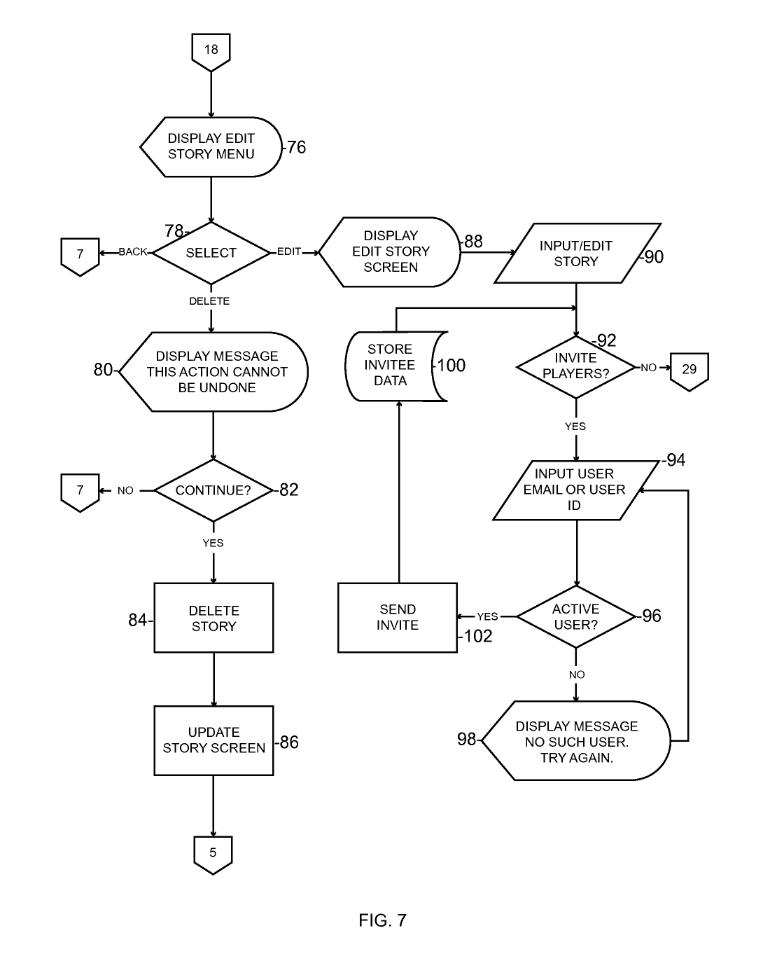

Because the user of this application may be involved in several role playing games during the same time period or a user may simply want to save a completed game, the application allows for the creation and storage of more than one story notebook. FIG. 7 is a flow chart depicting the process of maintenance of notebooks for separate stories/campaigns. The user at Box 18 begins the process of selecting a story to edit and the application displays a “Edit Story Menu” screen, Box 76. The user selects which story to access at Box 78 and chooses whether to edit the story at Box 88, delete the story at Box 80, or return to a previous screen at Box 7. If the user decides to delete a story at Box 80, the application will prompt a confirmation that the user has selected to delete the story at Box 82. If the user confirms to delete the story, the story will be deleted at Box 84, and the application will be updated to reflect the deletion. The application will display a message that the notebook has been updated at Box 86 and return to the story menu screen, Box 5. If the user decides not to delete the story at Box 82, then the application will return to the previous screen, Box 7. If the user elects to edit the story, Box 78, then the application will display a message that the selected story will be edited at Box 88, and the user will progress to input or edit story data at Box 90. When the user inputs or edits the story at Box 90, the application will allow the user to invite other players to join him or her, Box 92. If the user selects to not have others join him or her at Box 92, then the application will display all current players of the selected story at Box 29. If the user decides to invite other players to join the application at Box 92, then the user will be prompted to enter the invitee's email or other user identification at Box 94. If the invitee is an active user, Box 96, then the application will send an invitation to the invitee asking them to join the user in the selected story, Box 102. The invitee information is stored at Box 100 and saved in the user's notebook. If the invitee is not an active user of the application at Box 96, then the application will display a message that no such user exists and that the user should enter email or user identification information for a new invitee, Box 98.

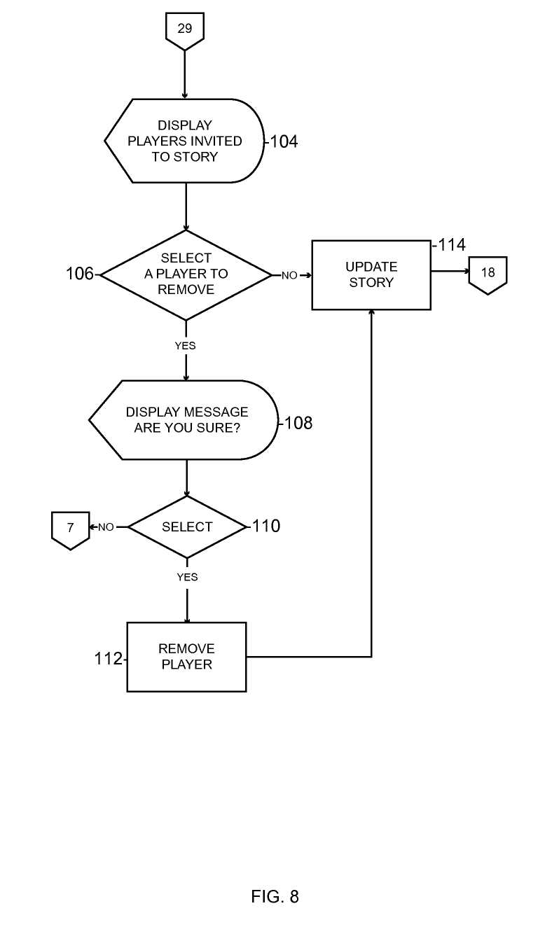

The Role Game Playing Notebook Application allows the user to delete other players from having continued access to their notebook. This process is depicted in the flow chart of FIG. 8. Once the user decides to delete another player at Box 29, the application will display a list of all players invited to join the story at Box 104, and the user will be prompted to select from a list a player or players to be deleted, Box 106. One the user has selected at least one player to delete at Box 106, then the application prompts the user to confirm they are certain of the deletion, Box 108. If the user confirms the deletion at Box 110, then the player is removed, Box 112, and the story is updated at Box 114. If the user declines to delete the selected player, Box 110, then the application will return to the previous screen at Box 7. Upon the successful update of player information, Box 114, the application progresses to the “Edit Story Menu” screen at Box 18.

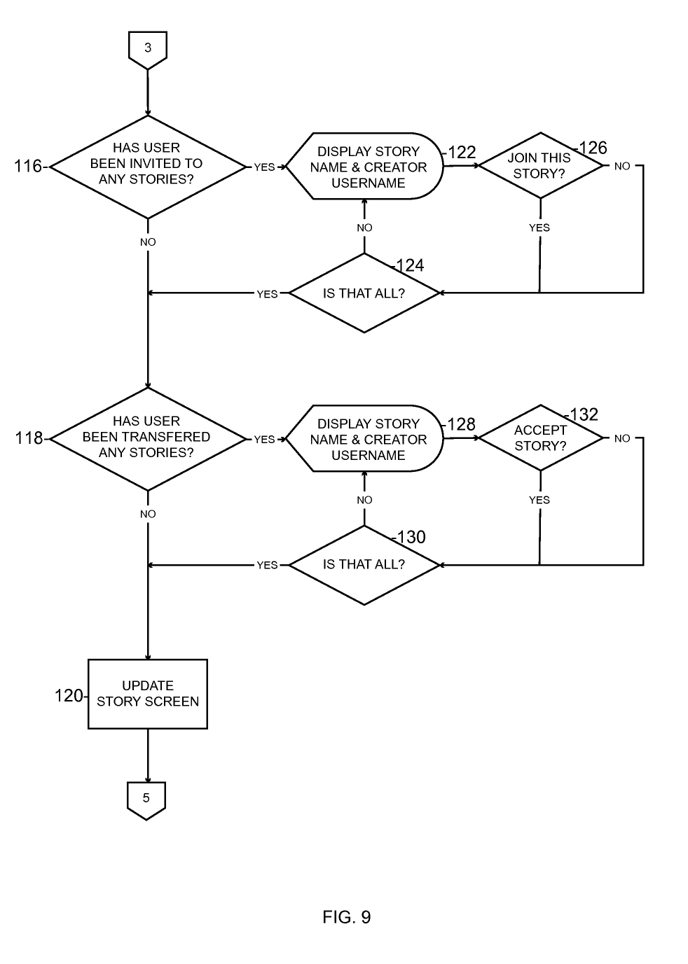

Once a user has invited by another to join one or more players in a story or stories, the application allows the user to edit which stories he or she chooses to join. FIG. 9 is a flow chart depicting the process of transferring the user's information to one or more story notebooks of other users. If a user has been invited to join the story of another user, Box 116, the application displays the name of each user and story that he user has been invited to join, Box 122. The user then decides whether to join the story of another at Box 126, and the application processes the user's desire at Box 124. Next, the application will inquire whether the user has been transferred to any stories, Box 118. If the user has not been transferred to another story, Box 118, then the story screen is updated at Box 120 and the application proceeds to the “Story Menu”, Box 5. If the user has been transferred to another's story at Box 118, then the application displays the name of the user and the story relation to the transfer, Box 128. The user has the option of accepting the story at Box 132. Once the user has opted to accept or decline the story, Box 132, the application processes the selection at Box 130.

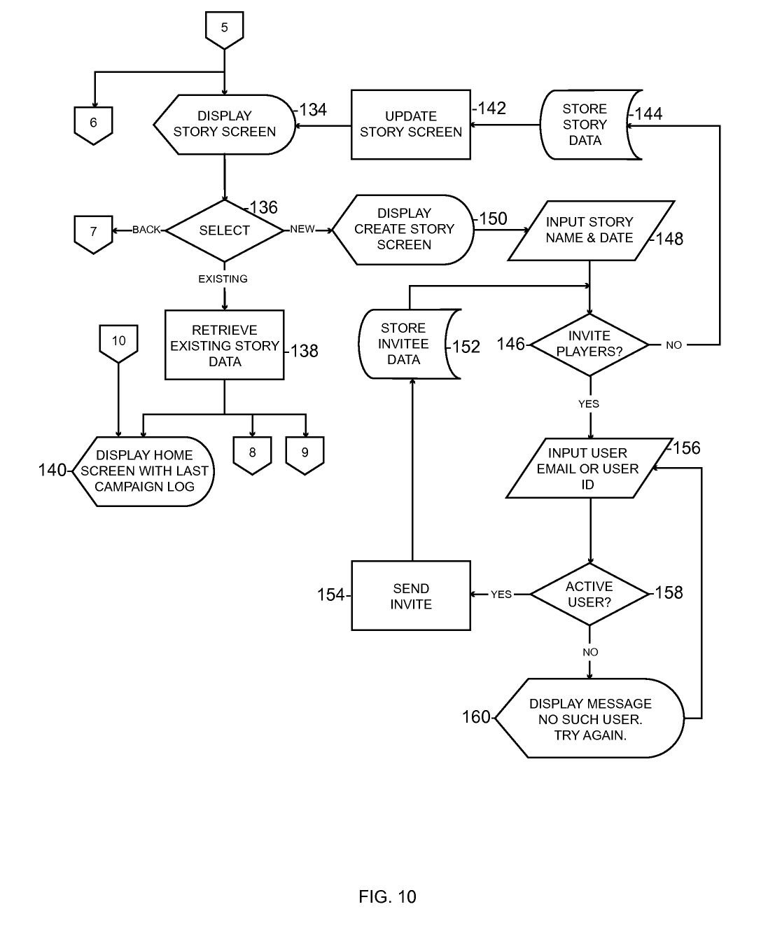

FIG. 10 is a flow chart illustrating the retrieval and editing of a story. The user at Box 5 elects to display the “Story” screen, Box 134. The user can select at Box 136 to go back to the previous screen at Box 7, to retrieve an existing story, Box 138, or to create a new story at Box 150. Once the story data has been retrieved, Box 138, the user can proceed to the “Navigation Menu” at Box 8, proceed to the “Story Sub Menu” at Box 9, or to display the “Home Screen” with the last campaign log at Box 140. A user at Box 10 can also opt to display the “Home Screen” at Box 140. If the user wants to create a new story at Box 136, the application displays a “Create Story” message, Box 150, and the user is prompted to input the story name and date at Box 148. The application then allows the user to invite other players, Box 146. If the user elects not to invite a new player or players, Box 146, then the application will store the story data at Box 144 and update the “Story” screen at Box 142. If the user elects to invite new players at Box 146, the application prompts the user to enter the email or user identification of the person(s) to be invited to join at Box 156. If the invitee is an active user, Box 158, then the application sends an invitation to the player asking them to join the story, Box 154. Invitee data is stored at Box 152. If the invitee is not an active user of the application at Box 158, then a message is displayed to the user stating that the invitee is not an active user and that the user may attempt to invite another user, Box 160.

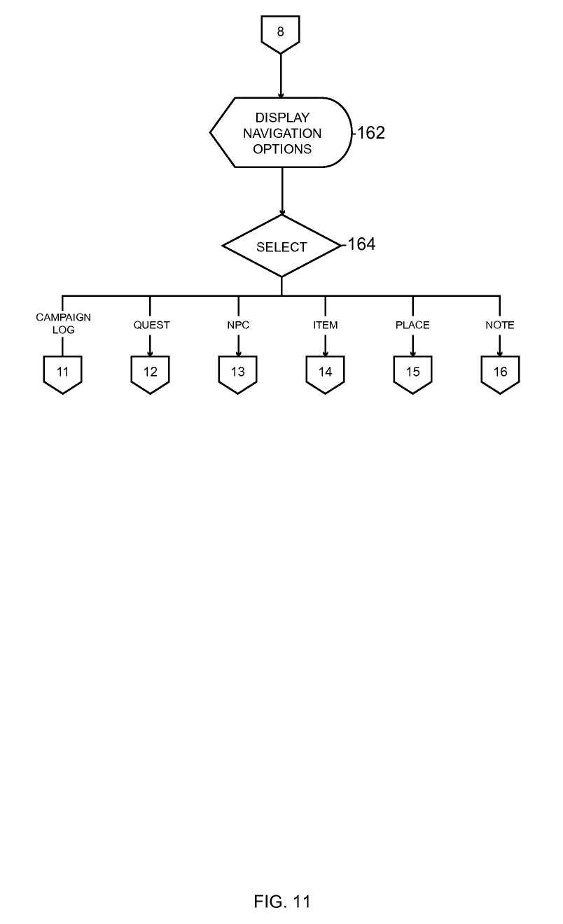

A user proceeds from the “Home” screen at Box 10 to the “Navigation Menu”, Box 8. FIG. 11 depicts the flow chart for the options available at the “Navigation Menu”. The application displays the “Navigation Menu” options at Box 162, and prompts the user to select at Box 164 from the following notebook pages: “Campaign Log” at Box 11, “Quest” at Box 12, “Non-Player Characters” at Box 13, “Items” at Box 14, “Place” or location at Box 15, and “Notes” at Box 16.

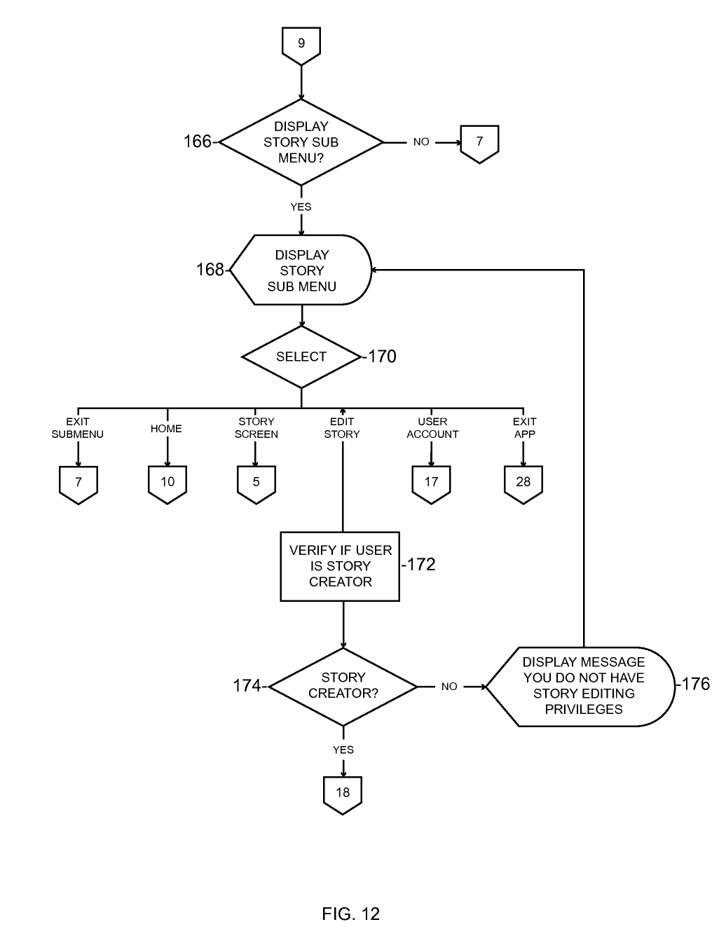

The user may choose to proceed from the “Home” screen, Box 10, to the “Story Sub Menu”, Box 9. The “Story Sub Menu” processes are depicted in the flow chart of FIG. 12. The user elects whether to display the “Story Sub Menu” screen, Box 166. If the user elects not to display the “Story Sub Menu”, Box 166, then the application returns to the previous screen at Box 7. If the user elects to display the “Story Sub Menu”, Box 166, then the “Story Sub Menu” is displayed at Box 168. At Box 170, the user has the Option to select one of the following menu options: to exit the “Story Sub Menu” at Box 7, to return to the “Home” screen at Box 10, to continue to the “Story” screen at Box 5, to access the user account at Box 17, to exit the application at Box 28, or to edit the current story. If the user elects to edit the current story, the application verifies that the user is the creator of the story at Box 172. If the user is the story creator at Box 174, then the application proceeds to the “Edit Story” screen at Box 18. If the user is not the creator of the story, Box 174, then the application displays a message that the user does not have story editing privileges at Box 176, and the application returns to Box 168 and displays the “Story Sub Menu”.

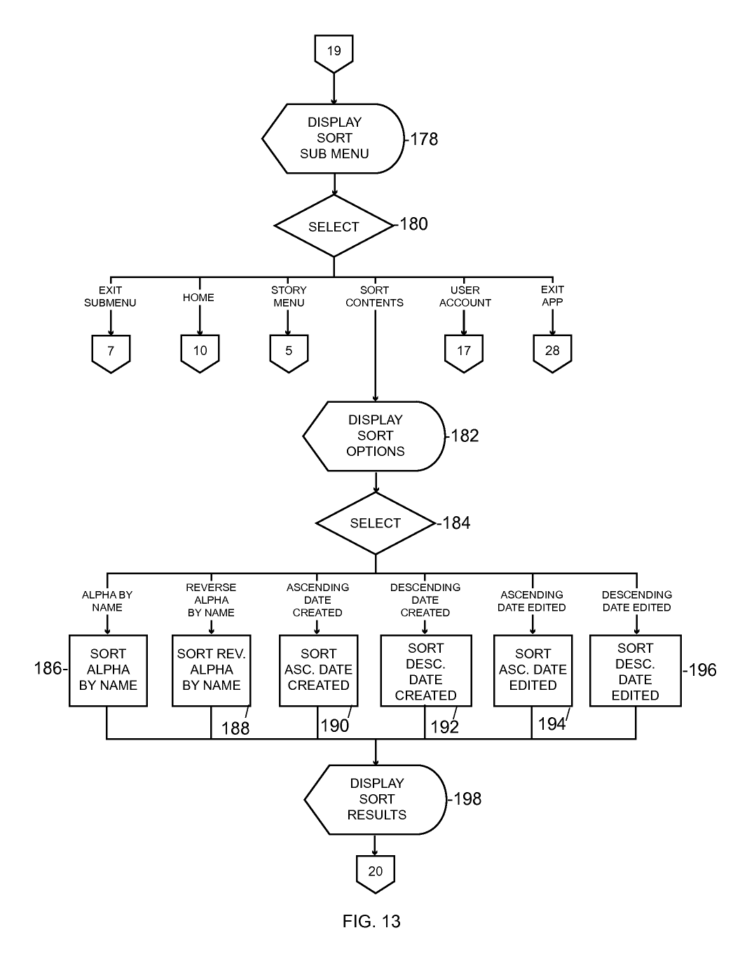

FIG. 13 is a flow chart illustrating the process of sorting within the application. The user prompts the application to display a “Sort Sub Menu” at Box 178. The user then has the option of electing to sort from the following options at Box 180: exiting the “Sort Sub Menu” at Box 7, returning to the “Home” screen at Box 10, proceeding to the “Story” menu at Box 5, accessing the user account at Box 17, exiting the application at Box 28, or sorting the contents, Box 182. Box 184 prompts the user to select to sort in one of the following ways: sorting by name alphabetically at Box 186, sorting by name in reverse alphabetical order at Box 188, sorting by ascending date at Box 190, sorting by descending date at Box 192, sorting by the ascending date that editing occurred at Box 194, or sorting by the descending date of editing at Box 196. The sorting results are displayed at Box 198.

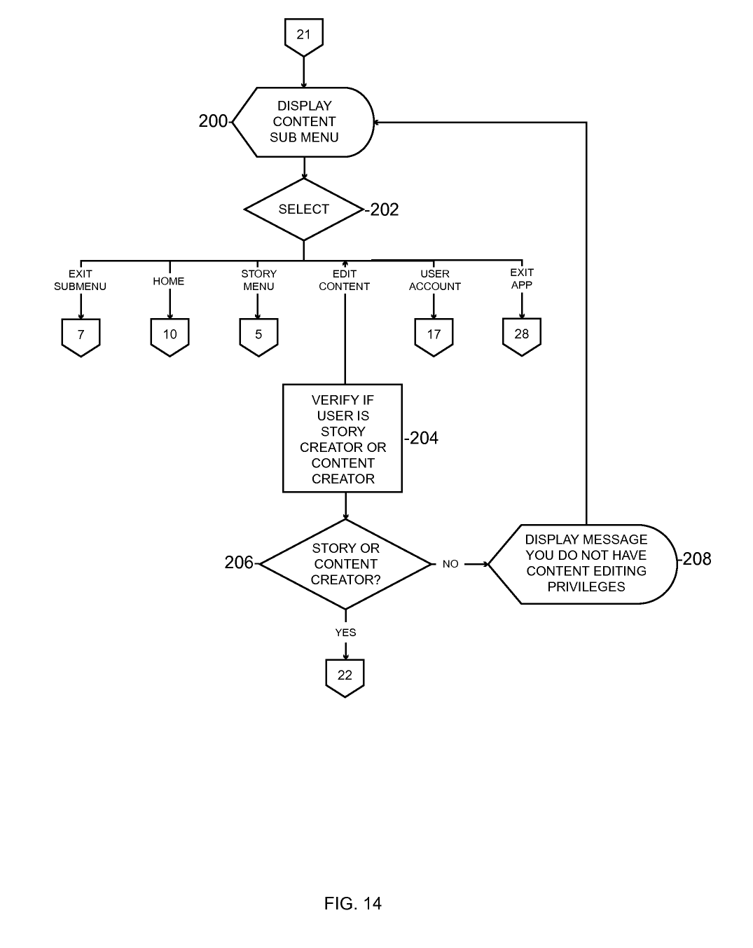

FIG. 14 is a flow chart illustrating the process for determining whether a user has content editing privileges. A user must have content editing privileges to edit the content of the electronic notebook. Initially, the application will display a “Content Sub Menu”, Box 202. At Box 202, this sub menu allows the user to elect among the following functions: exiting the sub menu at Box 7, returning to the “Home” screen at Box 10, proceeding to the “Story” menu at Box 5, accessing the user account at Box 17, exiting the application at Box 28, or editing the content. Before content can be edited, the application verifies that the user is the creator of the story or the content at Box 204. If the user is the story or content creator at Box 206, then the application proceeds to the “Content Edit” screen at Box 22. If the user is not the story or content creator at Box 206, then the application displays at Box 208 a message that the user does not have content editing privileges. The application returns the user lacking editing privileges to the “Content Sub Menu”, Box 200.

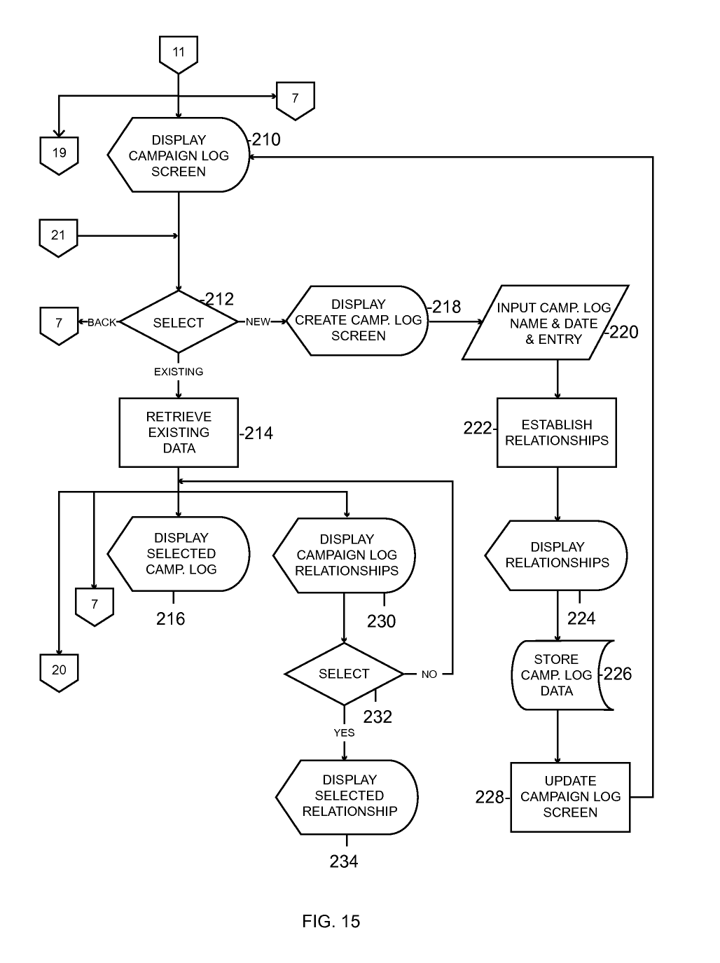

The process of creating “Campaign Log” notebook pages is depicted in the flow chart of FIG. 15. The application displays the “Campaign Log” screen at Box 210. Next, the user selects whether to return to the previous screen at Box 7, to retrieve existing data at Box 214, or to create a new “Campaign Log” page at Box 218. Campaign log data retrieved at Box 214 can be displayed at Box 216, can be sorted at Box 20, or campaign log relationships can be displayed at Box 230. Alternatively, the user can return to the previous screen at Box 7 after retrieving existing data at Box 214. If the user chooses to display campaign log relationships at Box 230, then the user will be prompted to select at Box 232 the relationship to be displayed at Box 234. If the user elects not to display a campaign log relationship at Box 232, then the application will allow the user to once again select whether to display selected “Campaign Log” notebook pages at Box 216, to return to the previous screen at Box 7, to display campaign log relationships, or to return to a previous menu at Box 7. If the user selects to create a new “Campaign Log” at Box 212, then the application will display a screen acknowledging the user's selection to create a new “Campaign Log”, Box 218. The user is then prompted to enter the name and date of the new “Campaign Log” page, Box 220, and establish relationships among characters at Box 222. Next, established relationships are displayed at Box 224, and the campaign log data is stored by the application, Box 226. The “Campaign Log” screen will then be updated at Box 228, and the application will once again display the “Campaign Log” screen, Box 210.

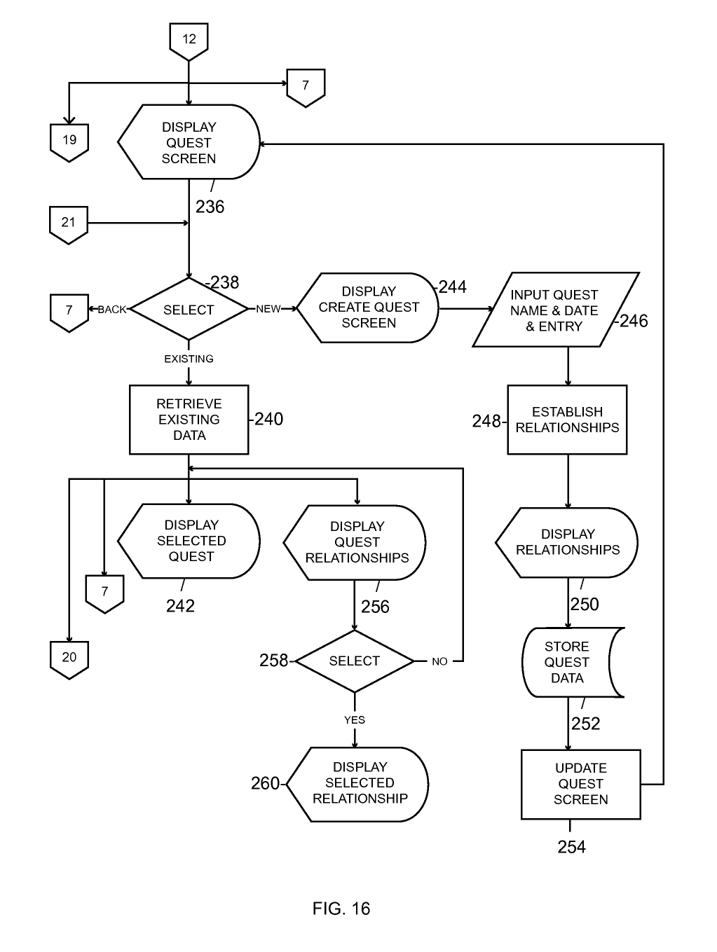

FIG. 16 is a flow chart illustrating the process of displaying a “Quest Log” screen. The user manipulates the application to display the “Quest” screen at Box 236. The application then prompts the user at Box 238 to retrieve existing data at Box 240, to create a new “Quest Log” electronic notebook page at Box 244 or to return to the previous menu at Box 7. If the user selects to retrieve an existing “Quest Log” at Box 238, the application retrieves the saved log at Box 240, and displays the selected quest at Box 242. Additionally, the user may select to display quest relationships at Box 256. Once the application displays the quest relationships at Box 256, the user is prompted to select a particular relationship to be displayed at Box 258. The selected relationship is displayed at Box 260. If the user does not select a particular relationship at Box 258, then the application allows the user to display sort results at Box 20, display a selected “Quest Log” page at Box 242, or return to a previous screen at Box 7. If the user selects at Box 238 to create a new “Quest Log”, the application will display the “Create Quest” screen at Box 244, and allow the user to enter a name for the quest and the date of entry at Box 246. The user then establishes relationships within the “Quest Log” at Box 248, which the application displays at Box 250 and stores at Box 252. Next, the application updates the “Quest Log” at Box 254, and displays the “Quest” screen, Box 236. The quest log will typically store information relating to the title of the quest, the quest giver, goals and tasks of the quest, locations for the quest to be played, rewards and benefits to achieve during the quest and any additional information relevant to the quest.

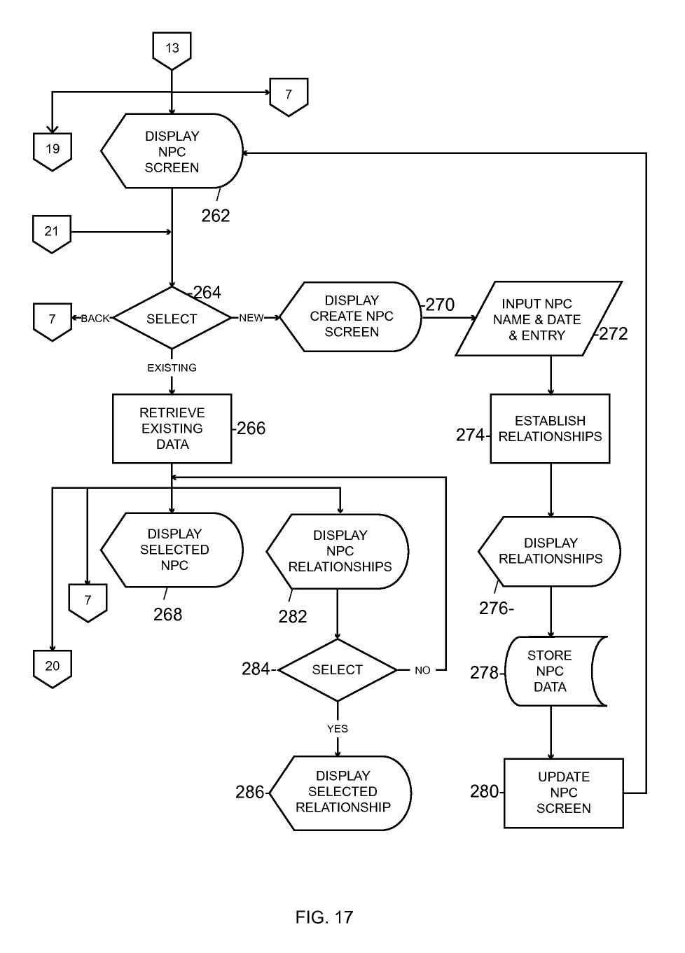

The process of creating and displaying Non-Player Character information is illustrated in the flow chart of FIG. 17. A user prompts the application to display the “Non-Player Character” (hereinafter “NPC”) screen at Box 262. The application prompts the user at Box 264 to select to retrieve existing data relating to NPCs, Box 266, or to create one or more new NPCs at Box 270. If the user selects to retrieve existing data at Box 266, the application will display the NPC notebook page at Box 268. The user is able to display NPC relationships at Box 282, and will be prompted to select whether to display NPC relationships, Box 284. If the user selects a NPC, then the application will display the selected relationship at Box 286. If the user opts not to display NPC relationships at Box 284, then the application allows the user to display a previously selected NPC at Box 268, to display sort results at Box 20, or to return to a previous screen at Box 7. If the user selects to create a new NPC at Box 264, the application will display a “Create Non-Player Character” screen at Box 270. The user is then prompted to enter the name of one or more NPCs and the date of the entry, Box 272. Relationships may be established between new and existing NPC at Box 274. The application displays all NPC relationships, Box 276, stores the NPC data at Box 278, and updates the “NPC” screen, Box 280. Next, the application returns the user to the “NPC” display screen at Box 262. A user may choose to store information relating to one or more NPCs such as the name of the NPC, a description of the NPC, NPC interactions, and whether the NPC is friendly, hostile, or neutral.

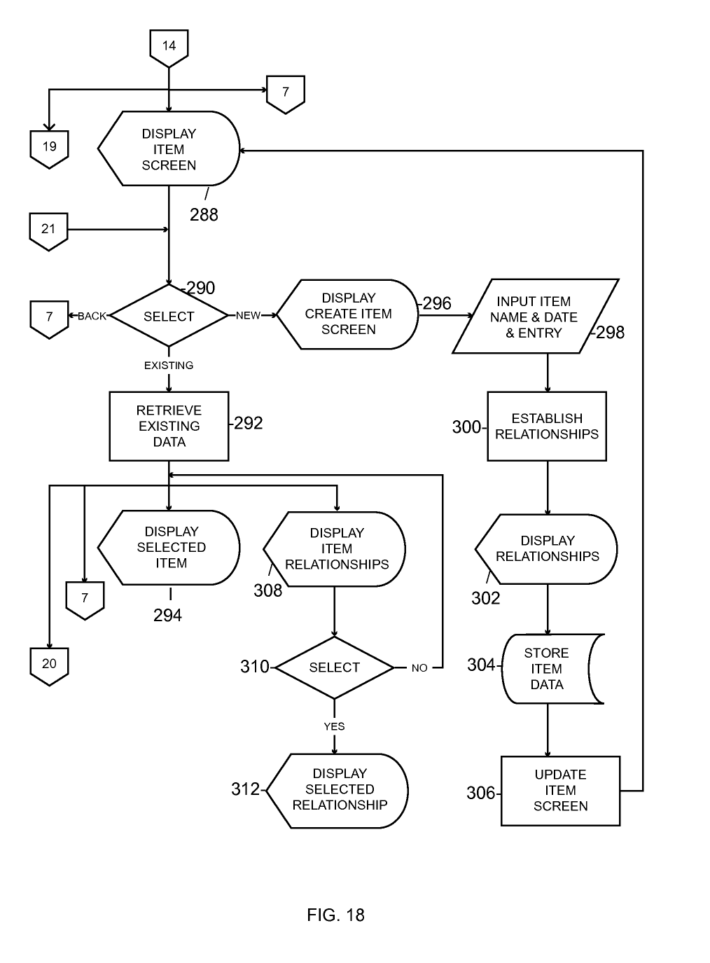

FIG. 18 is a flow chart illustrating the process of retrieving and creating an Item in the Role Playing Game Notebook Application. After the user opts to display the “Item” screen, Box 288, the application prompts the user to select to retrieve existing Item data, Box 292, or to create a new Item, Box 296. If the user opts to retrieve existing Item data at Box 292, the application displays the “Item” notebook page, Box 294. Once the selected Item page is displayed, Box 294, the application displays an “Items Relationships” screen, Box 308. The user is then prompted whether to display Item relationships, Box 310. If the user selects to display a relationship relating to an Item at Box 310, the application displays the relationship, Box 312. If the user selects not to display a relationship at Box 310, the application allows the user to either display the item selected for display at Box 294, to display sort resorts at Box 20, or to return to a previous screen at Box 7. If the user selects to create a new “Item” notebook page at Box 290, the application displays a “Create Item” screen which allows the entry of the name of the item and date at Box 298. The application then establishes relationships at Box 300. After any relationships have been established, the application stores item data at Box 304, and updates the “Item” screen at Box 306. The application then returns the user to the “Item” screen at Box 288. The user may want to store on the “Item” notebook page information relating to an item such as the item name, the type of item, a description of the item, advantages and disadvantages of the item, and any special properties of the item.

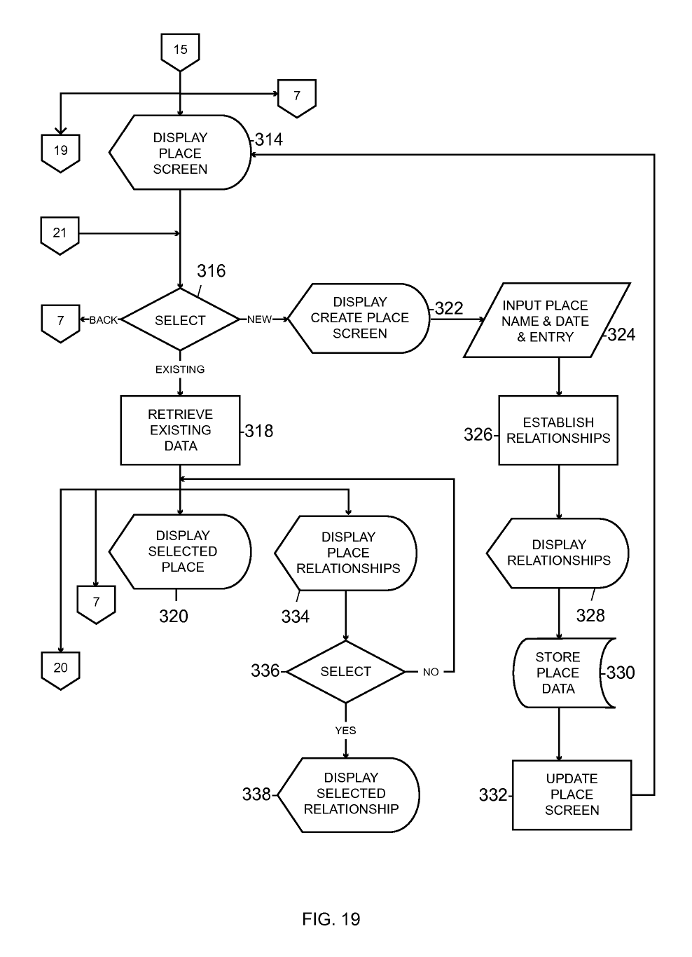

The process to retrieve and create a “Place” notebook page is disclosed in the flow chart of FIG. 19. The user elects to display the “Place” screen, Box 314. The application then prompts the user to select whether they want to retrieve an existing “Place” notebook page, Box 318, or to create a new “Place” notebook page at Box 322. If the user selects to retrieve existing data at Box 318, the data relating to an existing place is displayed at Box 320. The application displays place relationships at Box 334 and allows the user to select whether to display relationships for each selected place, Box 336. If the user opts to display a relationship of a selected place, the relationship is displayed at Box 338. If the user declines to display a relationship for the selected place, the application then allows the user to return to screen displaying the selected place at Box 320, to display sort results at Box 20, or to return to a previous screen at Box 7. If a user selects to create a new place at Box 316, the application displays a “Create Place” screen, Box 322. The user then inputs information relating to the name of the place and date at Box 324. Relationships for the new place entered can be established, Box 326. These new relationships are displayed, Box 328, the data is stored, Box 330, and the “Place” screen is updated with the new place and any relationship at Box 332. The application then returns to the “Place” screen, Box 314. A user may list information relating to a place such as the name of the place or location, a description of the place, the relevance of the place to the story, and whether the population inhabiting the place is friendly, hostile, or neutral.

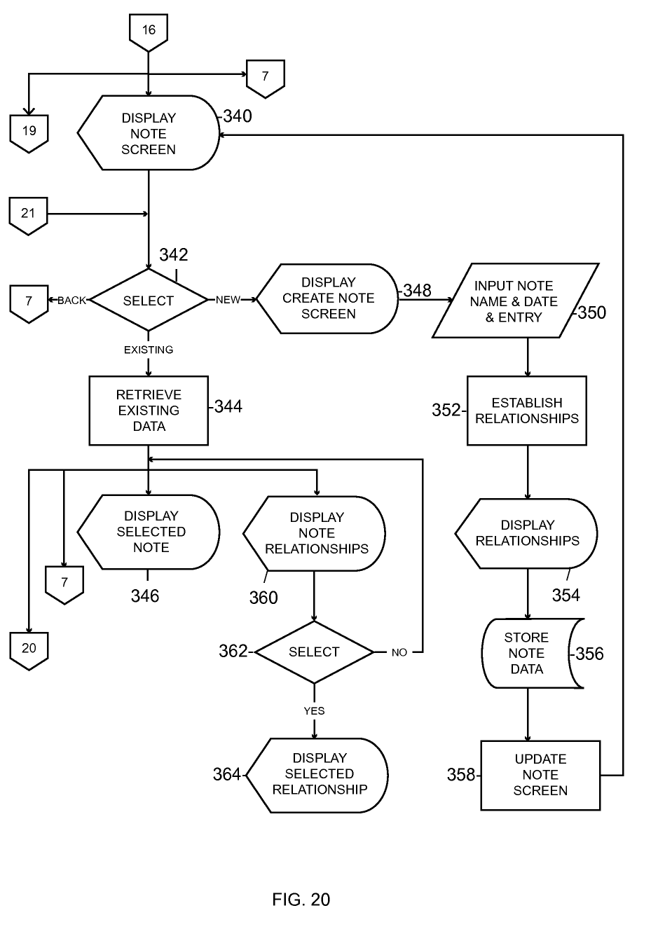

FIG. 20 is a flow chart depicting the retrieval and creation of notebook pages for Notes in the Role Playing Game Application Notebook. The “Note” screen is displayed at Box 340. The user is prompted at Box 342 to select to retrieve an existing “Note” notebook page, Box 344, or to create a new “Note” notebook page, Box 348. If the user selects to retrieve an existing “Note” page at Box 344, the application will display the “Note” page selected, Box 346. The application displays note relationships, Box 360, and prompts the user at Box 362 to select whether to display a selected relationship. If the user selects to display a selected relationship at Box 364, the relationship is displayed, Box 364. If the use selects to not display a selected relationship at Box 362, the application will allow the user to display the selected note at Box 346, to display sort results at Box 20, or to return to a previous screen at Box 7. If the user selects to create a new “Note” notebook page at Box 342, the application displays the “Create Note” screen, Box 348, and allows the user to enter the name and date of each note to be added, Box 350. The application then allows relationships to be established at Box 352, and displays any relationships added at Box 354. The new note(s) and relationship(s) are stored, Box 356, and the “Note” screen is updated, Box 358. The application then returns the user to the “Note” screen, Box 340. The user may want to store information on the “Note” notebook page(s) relating to any aspect of the Role Playing Game the user wishes to store.

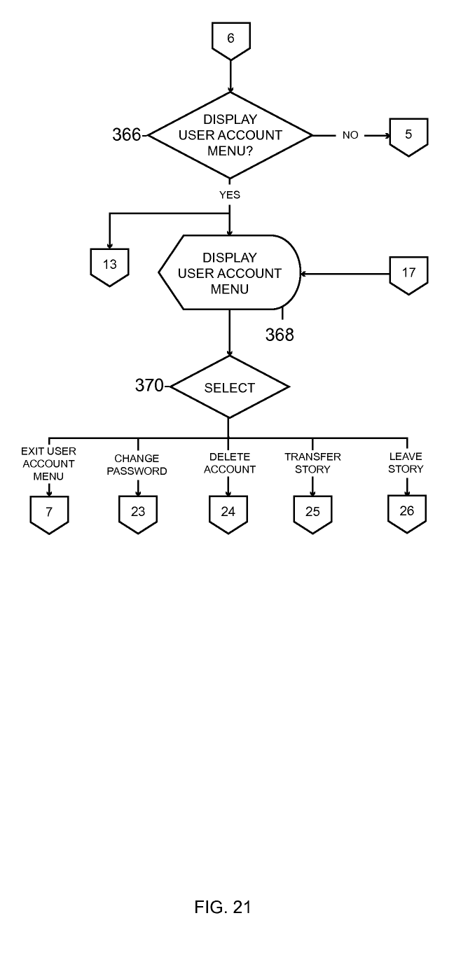

Processes available through the “User Account Menu” are depicted in the flow chart of FIG. 21. The “User Account Menu” prompts the user whether they would like to access the user account preferences at Box 366. If the user opts to access the account menu at Box 366, the application displays the “User Account Menu” screen, Box 368, and prompts the user to select from the following menu items: exiting the “User Account Menu” at Box 7, changing the password at Box 23, deleting the account at Box 24, transferring the story at Box 25, and leaving the story at Box 26. If the user chooses not to access the account preferences at Box 366, the application will transfer the user to the “Story Menu” screen, Box 5.

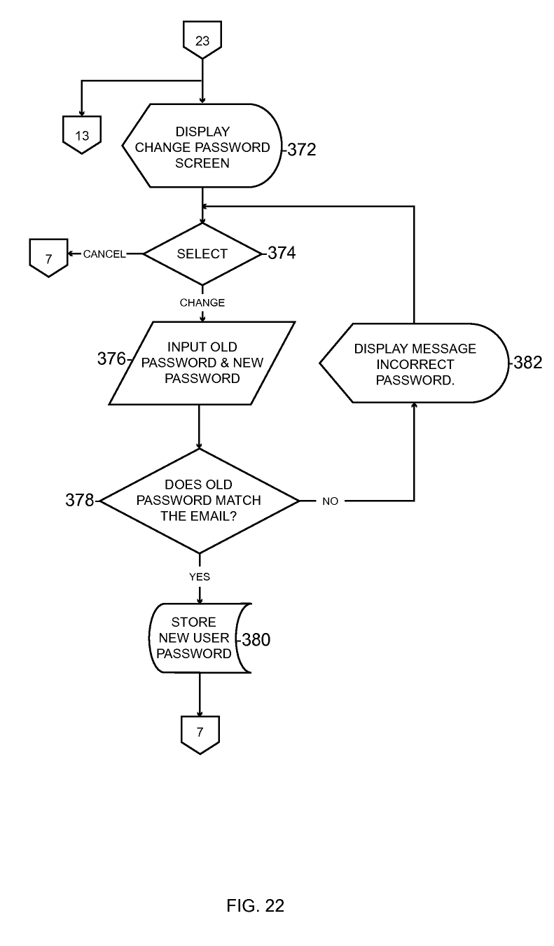

The process of changing the user password for the application is illustrated in the flow chart of FIG. 22. If the user selects to change the password at Box 23, the application will display the “Change Password” screen, Box 372. The application at Box 374 prompts the user to either select to change the password or to return to the previous screen, Box 7. If the user selects to change the password at Box 374, the user is required to input the old password and select a new password, Box 376. The application checks to ensure that the new password selected does not match the previous password, Box 378. If the new password selected differs from the old password, Box 378, then the application stores the new user password at Box 380 and returns to the previous menu, Box 7. If the new password selected by the user matches the old password at Box 378, the application displays a message that an incorrect password has been selected, Box 382, and the application returns the user to the “Change Password” screen at Box 372.

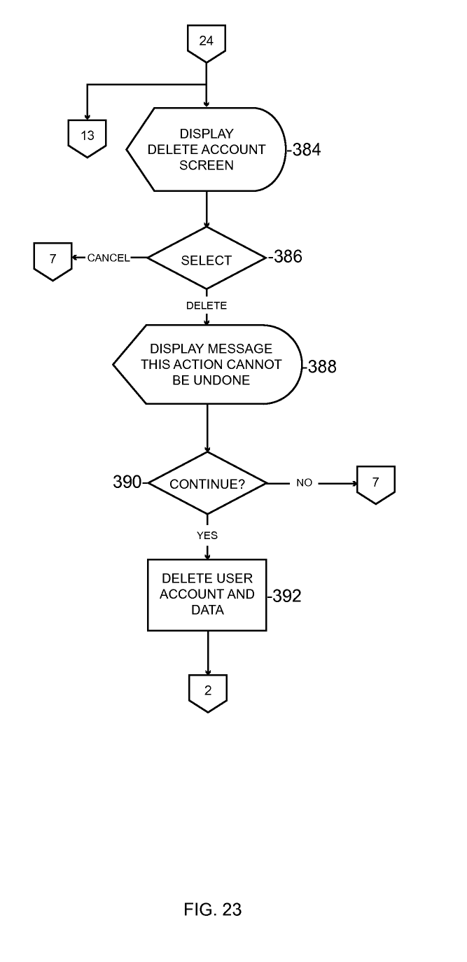

The flow chart depicted in FIG. 23 describes the process utilized by the application to delete an user account. If the user opts to delete his or her account, the application displays a “Delete Account” screen, Box 384. The user is then prompted to select whether to delete his or her account at Box 386. If the user selects to delete their account at Box 388, the application displays a message to inform the user that the action can not be undone once completed, Box 388. If the user selects to not delete their account at Box 386, the application returns the user to the previous screen at Box 7. The user is prompted a second time to confirm that they have selected to delete their user account, Box 390. If the user elects a second time to delete their account, Box 390, then the application deletes the user account and all data associated therewith, Box 392, and returns the user to the “Log In” screen at Box 2. If the user declines to delete their account at Box 390, then the application returns the user to the previous screen at Box 7.

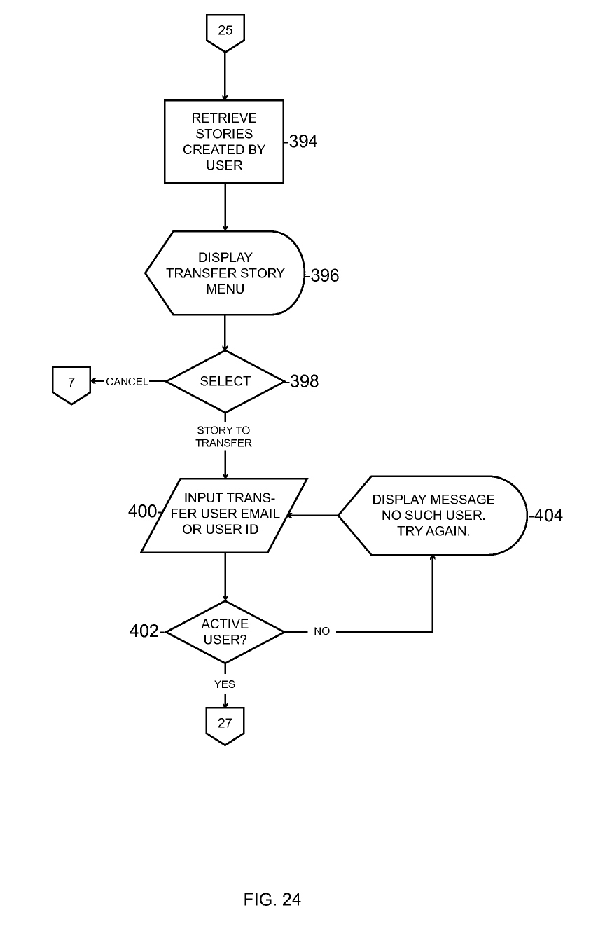

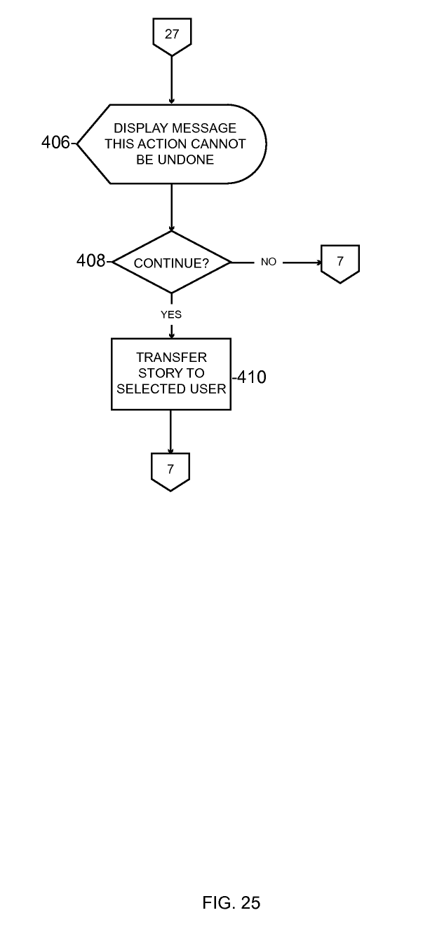

FIG. 24 and FIG. 25 are flow charts depicting the process utilized by the invention herein to transfer Story data to another user. When a user desires to transfer one or more stories from their notebook to another user's notebook, Box 394, the application will display a “Transfer Story” menu, Box 396. The user will then be prompted to select a story to transfer at Box 398. If the user selects at Box 398 not to transfer a story to another user, the application will return the user to the previous screen at Box 7. Once the story is selected at Box 398, the user is required to input their email address or user identification and to enter the user information for the user that is to receive the story, Box 400. If the user designated to receive the story is not recognized as an active user at Box 402, the application displays a message that no such user is recognized and that the user should “Try Again”, Box 404. The application transfers the user from Box 404 to Box 400, where the user is asked to enter their email or user identification. If the user is recognized by the application as an active user at Box 402, the application will display a message that once the story is transferred, the action can not be undone at Box 406. The user will then be prompted to confirm whether they wish to continue to transfer the story, Box 408. If the user confirms at Box 408 to transfer the story, the application will transfer the story to the requested user account at Box 410. Upon the transfer of the story at Box 410, the application returns the user to the previous screen, Box 7. If the user selects not to continue with the transfer of the story at Box 408, then the application transfers the user to the previous screen at Box 7.

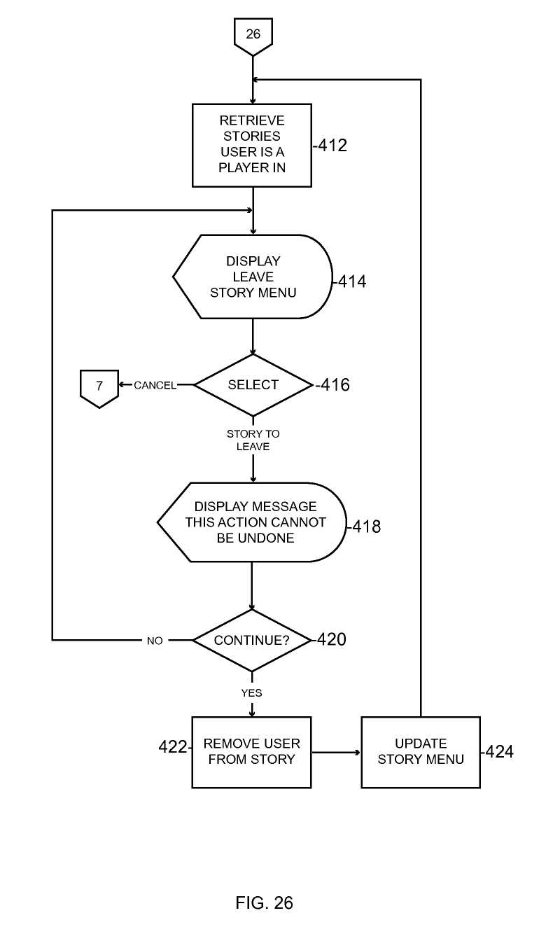

The process employed by the application to leave a story menu is depicted in the flow chart of FIG. 26. The user must retrieve all stories that a user is listed as a player, Box 412. The application displays a “Leave Story” menu, Box 414, and prompts the user to select to leave a selected story at Box 416. If the user selects not to leave the story, the user is returned to the previous screen at Box 7. If the user selects to leave a selected story, Box 416, the application displays a message that the action can not be undone, Box 418. The user is prompted to confirm that they want to leave the story at Box 420. If the user confirms to leave the story at Box 420, the application will remove the user from the selected story, Box 422, and update the “Story” menu, Box 424. Once updating is complete, the user is returned to the “Leave Story” screen, Box 26. If the user at Box 420 does not confirm that he or she desires to leave the selected story, the application returns the user to the “Leave Story” menu, Box 414.

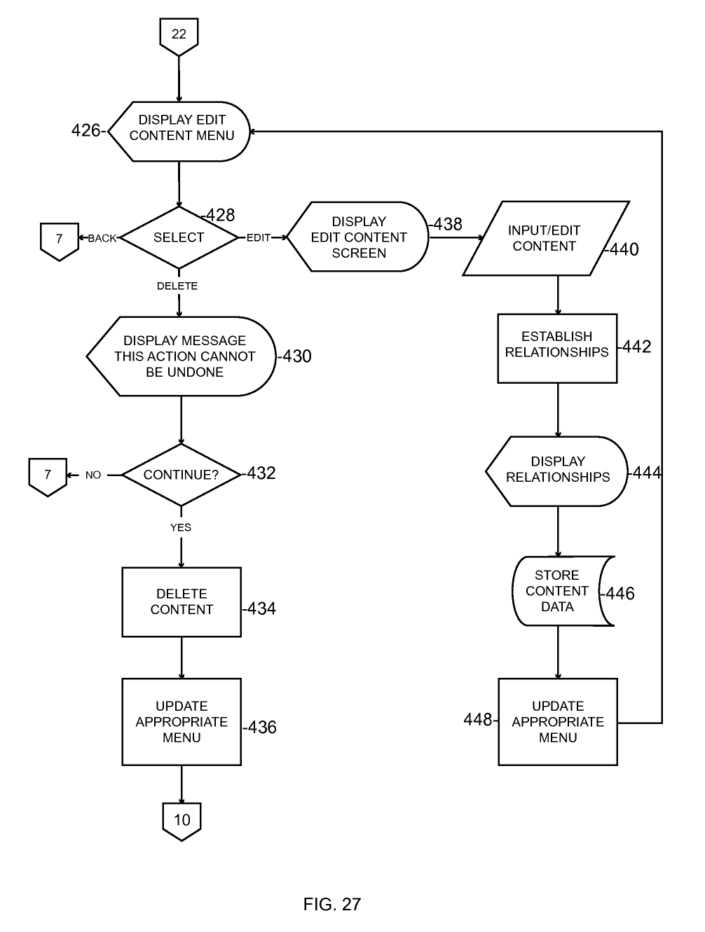

FIG. 27 is a flow chart depicting the process of editing content that has been saved in the user's notebook. The application displays a “Edit Content” menu, Box 426, and prompts the user to select to delete saved content at Box 428. The user can select to return to the previous screen at Box 7, delete content at Box 430, or edit content at Box 438. If the user selects to delete content at Box 428, the application will display a message that the action can not be undone, Box 430. The application then prompts the user to confirm that he or she wants to delete the selected content, Box 42. If the user selects not to delete content, the application returns the user to the previous screen at Box 7. If the user confirms the deletion of content at Box 432, the application deletes the selected content, Box 434, updates the appropriate menu, Box 436, and returns the user to the “Home” screen at Box 10. If the user selects to edit content at Box 428, the application displays an “Edit Content” screen, Box 438. The user then enters the content desired to be edited at Box 440 and whether any established relationships should be edited at Box 442. The application displays the relationships to be edited, Box 444, and stores edited content data at Box 446. The application updates the appropriate menu at Box 448 and returns the user to the “Edit Content” menu screen, Box 426.

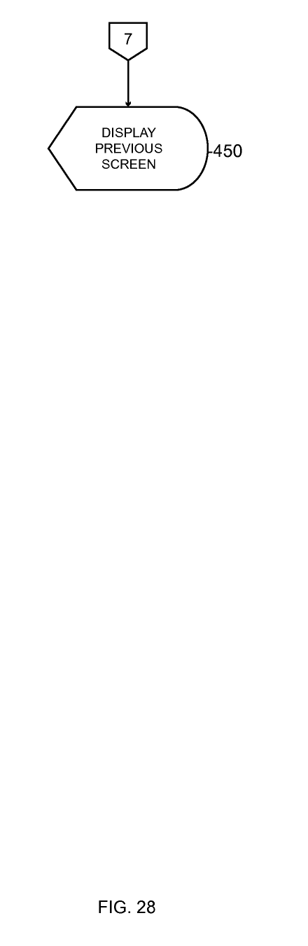

FIG. 28 is a flow chart illustrating the process of returning to a previous screen. The user selects to go back to the previous screen, Box 450, and the application returns the user to the previous screen.

The inventor hereby claims:

1) A method of collecting data and game content of a Role Playing Game, storing said data and game content, and automatically transforming said data and game content into an electronic notebook:
wherein the electronic notebook comprises a plurality of web pages,
wherein the method further comprises:
a server;
a game client configured as an application on an electronic device of the player; and
automatically generated personal notebook pages for a player.

2) The method of claim 1, wherein said electronic device is a personal computer, a mobile phone, a laptop computer, the Internet, or a proprietary website.

3) The method of claim 1 further comprising a filter or search function to allow said player to filter or search said notebook on said electronic device.

4) The method of claim 1 further comprising an edit function to allow said player to edit data stored within said notebook on said electronic device.

5) The method of claim 1 further comprising a delete function to allow said player to delete data stored within said notebook on said electronic device.

6) The method of claim 1 further comprising a notebook with a page that contains data relating to said Role Playing Game campaigns.

7) The method of claim 1 further comprising a notebook with a page that contains data relating to said Role Playing Game quests.

8) The method of claim 1 further comprising a notebook with a page that contains data relating to non-character players encountered in said Role Playing Game.

9) The method of claim 1 further comprising a notebook with a page that contains data relating to places encountered in said Role Playing Game.

10) The method of claim 1 further comprising a notebook with a page that contains data relating to Items encounter in said Role Playing Game.

11) The method of claim 1 further comprising a notebook with a page that contains data relating to notes of the player.

12) A data processing system for collecting data and game content of a Role Playing Game, storing said data and game content, and automatically transforming said data and game content into an electronic notebook
wherein the electronic notebook comprises a plurality of web pages,
wherein the system further comprises:
a server;
a game client configured as an application on an electronic device of the player; and
automatically generated personal notebook pages for a player.

13) The system of claim 16 wherein the electronic device is a personal computer, a mobile phone, a laptop computer, the Internet, or a proprietary website.

14) The system of claim 16 further comprising a filter or search function to allow said player to filter or search said notebook on said electronic device.

15) The system of claim 16 further comprising an edit function to allow said player to edit data stored within said notebook on said electronic device.

16) The system of claim 16 further comprising a delete function to allow said player to delete data stored within said notebook on said electronic device.

17) The system of claim 16 further comprising a notebook with a page that contains data relating to said Role Playing Game campaigns.

18) The system of claim 16 further comprising a notebook with a page that contains data relating to said Role Playing Game quests.

19) The system of claim 16 further comprising a notebook with a page that contains data relating to non-character players encountered in said Role Playing Game.

20) The system of claim 16 further comprising a notebook with a page that contains data relating to places encountered in said Role Playing Game.
